(19) United States
(12) Patent Application Publication
(10) Pub. No.: US 2005/0205638 A1
(43) Pub. Date: Sep. 22, 2005

(54) Single orderly striking device for a nail gun

(75) Inventor: Brian Wang, Changhua County (TW)

Correspondence Address: TROXELL LAW OFFICE PLLC, SUITE 1404, 5205 LEESBURG PIKE, FALLS CHURCH, VA, 22041, US

(73) Assignee: Bentley Fastening Tools Co., Ltd.

(21) Appl. No.: 10/805,263

(22) Filed: Mar. 22, 2004

(51) Int. Cl. B25C 1/04

(52) U.S. Cl. 227/8; 227/130

(57) ABSTRACT

An orderly single striking device for a nail gun includes a press plate provided with a projection to contact and push always a valve switch to let pressure air to continue flowing into a cylinder of the nail gun so as to move forward the piston with a striking needle to the front position to complete nail striking action, even if the piston should stop at a middle way of its stroke due to some cause and block wind holes in an annular wall of the cylinder after the trigger is pulled for striking a nail. So the device can prevent a nail from being stricken in vain or intermittently, smoothing striking action and upgrading work efficiency of the nail gun.

### BACKGROUND OF THE INVENTION

1. Field of the Invention

This invention relates to a nail gun, particularly to a single orderly striking device for a nail gun, which can effectively prevent a nail from stricken in vain or intermittently, attaining smooth orderly striking for a single nail of packed nails one by one.

2. Description of the Prior Art

In using a conventional nail gun, a user has to place one end of a safety arm of the nail gun on the surface of a work, with the other end of the safety arm pushing a press plate pivotally connected with a trigger. Then the trigger is pulled to force the press plate to activate a valve switch so that pressured air may flow into a cylinder to push and move a piston with a striking needle, which then moves forward very fast to strike a nail in a work. During the striking process, the piston slides through a one-way wind hole in the wall of the cylinder and allows pressured air to flow through the one-way wind hole into a lower air chamber. Then the pressured air flowing in the lower air chamber may flow back to the front section of the cylinder before the end of the piston through a return wind hole in the wall of the cylinder so that the striking piston may be pushed back to its original position for a next round of striking another nail.

On the other hand, at the moment of striking a nail by the nail gun, the safety arm receives reaction to jump off the surface of the work, forcing the other end of the safety arm to separate from the press plate of the trigger, which then may rotate to return to its original position, with the valve switch also moved back to turn-off condition, stopping pressured air from flowing continually into the cylinder for moving the piston, which returns to its original position to be ready for next striking.

However, a nail may not be possible to be continually stricken orderly but be stricken intermittently or in vain, mainly because of the surface of a work being too hard or some other cause, with the striking needle of the piston unable to strike a nail completely into the work and with the piston moved to slide only half its stroke and stop at a middle way hiding the wind hole so pressured air cannot flow into the lower air chamber. Thus, the piston cannot be moved back by pressured air and stops at a half way and cannot move back to its original position. In addition, the nail gun may get a reaction to instantly jump off the surface of the work at the moment when the striking needle of the piston strikes to push a nail into the work. Then the other end of the safety arm may leave off the press plate of the trigger at that moment, letting the press plate pivotally return to its original position and no longer press the air valve switch, and accordingly the valve switch is moved to its turned-off position, with pressured air impossible to flow into the cylinder to push the piston back to its original position. Therefore, even if a user pushes the safety arm to the surface of the work once again for next round of striking action, the next nail is impossible to enter the nozzle of the nail gun because of the striking needle still staying therein and hampering the next nail from entering. Thus a nail cannot orderly be stricken out, resulting in nails stricken intermittently or in vain. Then the nail gun cannot work again, unless a user waits until the piston recovers its original position. Then this erroneous operation can cause great inconvenience to a user.

### SUMMARY OF THE INVENTION

This invention has been devised to offer a single orderly striking device for a nail gun. The device includes a projection formed on a press plate positioned just behind the trigger of a nail gun, and the projection always contacts and pushes a valve switch so as to let pressured air continue flowing into the cylinder of the nail gun, even if the piston stops at a middle way in its stroke and blocks a wind hole of a wall of the cylinder. Then the safety arm has its inner end leaving off the press plate, so when the press plate recovers its original position, the projection still keeps on pushing the valve switch, permitting pressured air continue to flow into the cylinder to move the piston with a striking needle forward, clearing the blocked wind hole. Therefore, the erroneous action of the nail being stricken intermittently or in vain can be prevented.

### BRIEF DESCRIPTION OF DRAWINGS

This invention will be better understood by referring to the accompanying drawings, wherein:

FIG. 1 is a side cross-sectional view of a nail gun with a single orderly striking device in a normal condition in the present invention;

FIG. 2 is a perspective view of a press plate in the present invention;

FIG. 3 is a side cross-sectional view of a safety arm being pressed inward in the present invention;

FIG. 4 is a side cross-sectional view of a striking piston moving forward after trigger pulled in the present invention;

FIG. 5 is a cross-sectional view of a safety arm returning to its original position after triggering in the present invention;

FIG. 6 is a cross-sectional view of the piston returning to its original position after triggering in the present invention; and,

FIG. 7 is a cross-sectional view of the piston staying temporarily at a middle way in its stroke after the trigger pulled in the present invention.

### DETAILED DESCRIPTION OF THE PREFERRED EMBODIMENT

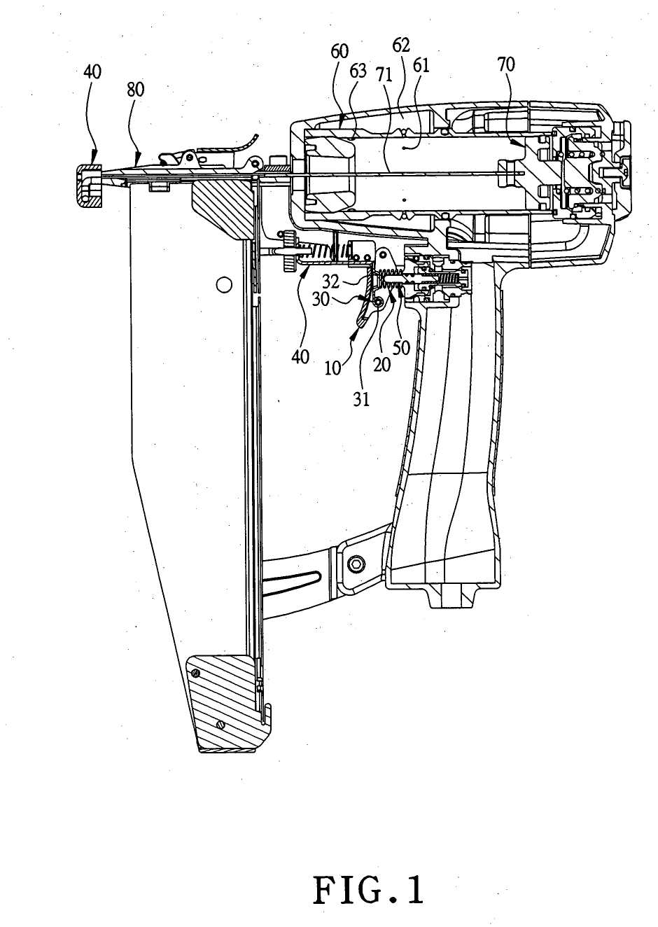

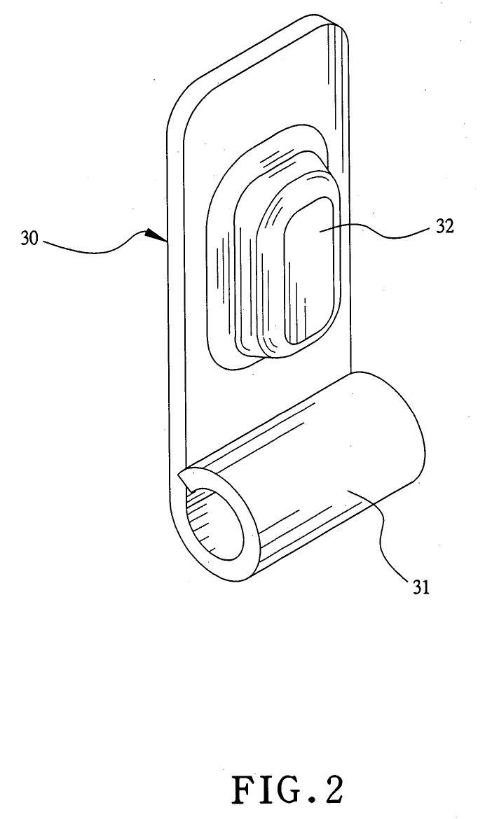

A preferred embodiment of a single orderly striking device for a nail gun in the present invention, as shown in FIGS. 1 and 2, has the generally same structure as the conventional nail gun described above, including a trigger 10, a coil spring 20, and a press plate 30 pivotally fixed and connected with the coil spring 20 and moved by the trigger 10 to be in due time rotated by a safety arm 40 to push an valve switch 50 to activate a round of striking action against a nail.

The press plate 30 has a pivot wound ear 31 formed at a lower end for pivotally fixing itself at a preset position behind the trigger 10, and a projection 32 formed integral and recessed inward by pressing process at an upper section to contact and push always a front end of the valve switch 50. The projection 32 has a height for the trigger 10 always in the condition 32 resting against the press plate 30. When the safety arm 40 leaves off the press plate 30, the projection 32 still presses the valve switch 50 to be kept in an open condition so that pressured air may continue to flow into the cylinder 60 for pressing and moving the piston 70, in stricken or in vain.

Next, the normal condition and the special condition of the press plate 30 are to be described as below.

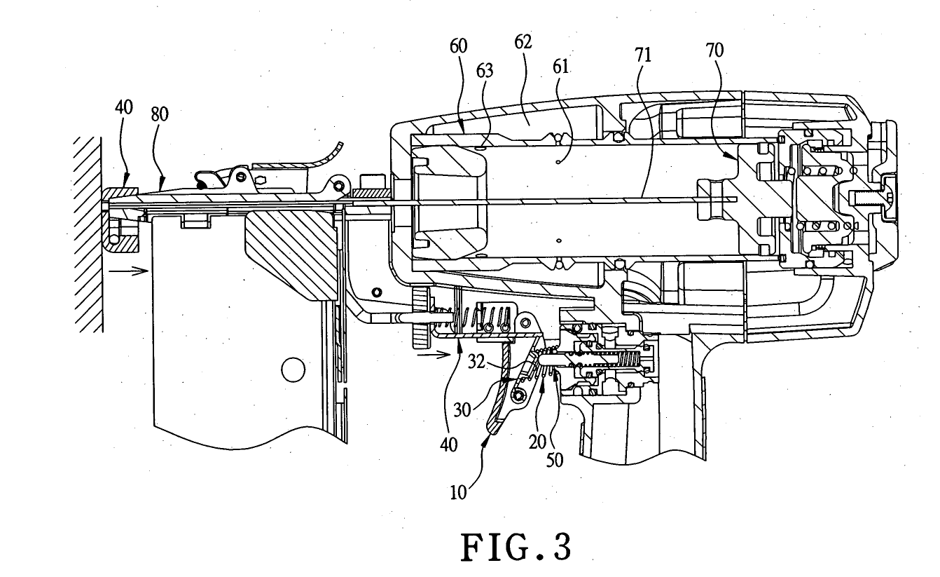

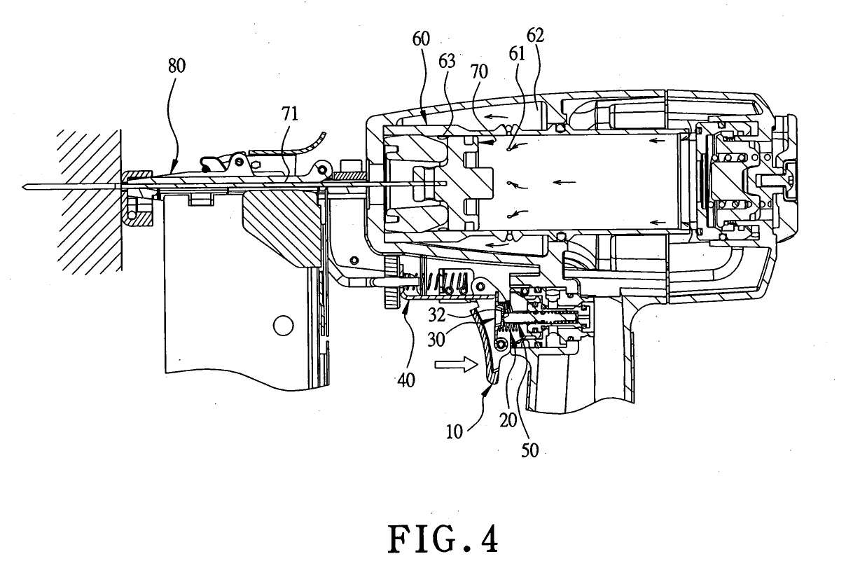

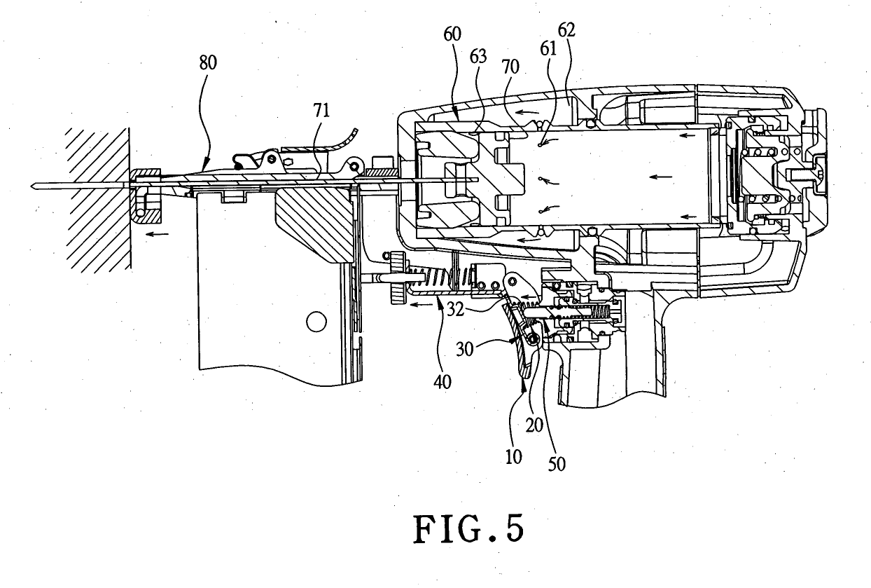

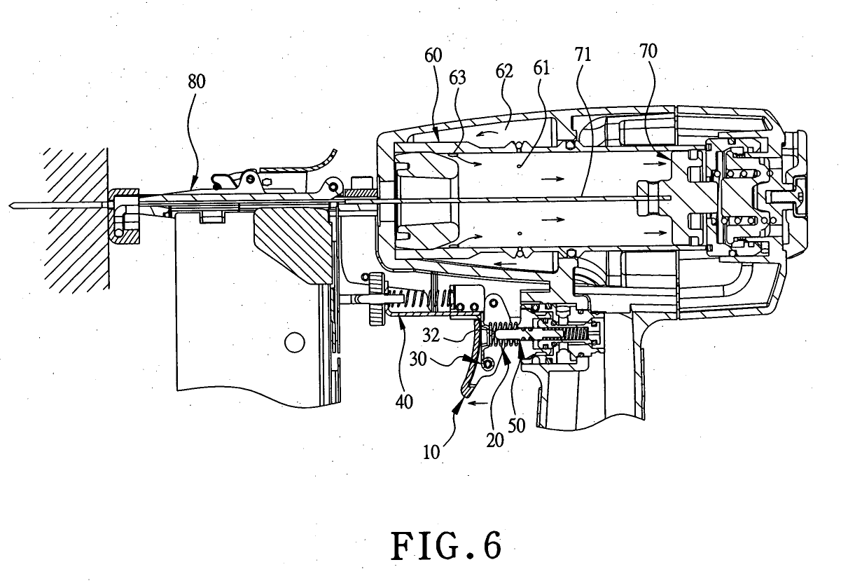

(1) In the normal condition: referring to FIGS. 3, 4, 5 and 6, when the nail gun is triggered, in other words, the trigger 10 is pulled backward, the piston 70 at the normal position shown in FIG. 3 is moved to slide to the front position shown in FIG. 4, with a striking needle 71 extending forward from the piston 70 striking one of packed nails positioned in a nozzle 80 into a work (not shown). This is the normal striking action of the nail gun, and in details, when a user wants to make a round of striking a nail, the user places the front end of the safety arm 40 to push an upper surface of a work, letting the inner end of the safety arm 40 push the press plate 30 to pivotally rotate, and then at once the trigger 10 is pulled as shown in FIG. 4. Then the press plate 30 pushes the valve switch 50 to open for allowing pressured air to flow in the cylinder 60 and push the piston 70 to move very fast forward, with the striking needle 71 fixed with the piston 70 striking forward one of packed nails in the nozzle 80 into a work. The reaction caused by the striking action may force the front end of the safety arm 40 to jump off the surface of the work, as shown in FIG. 5, and the inner end of the safety arm 40 accordingly leaves off the press plate 30, which then moves back to its original position. Nevertheless, the projection 32 of the press plate 30 still keeps pushing the valve switch 50 so pressured air still continues to flow into the cylinder 60. But the user always lets loose the trigger 10 customarily after finishing triggering, as shown in FIG. 6, for next round of striking or stopping. After the trigger 10 is released, the press plate 30 accordingly separates from the valve switch 50, blocking pressured air from flowing into the cylinder 60, but letting it possible to flow through plural wind holes 61 into the lower chamber 62 and then through plural return wind holes 63 into the front section of the cylinder 60 in front of the piston 60 to push back the piston 60 to its original position, not to be activated by the projection 32 of the press plate 30.

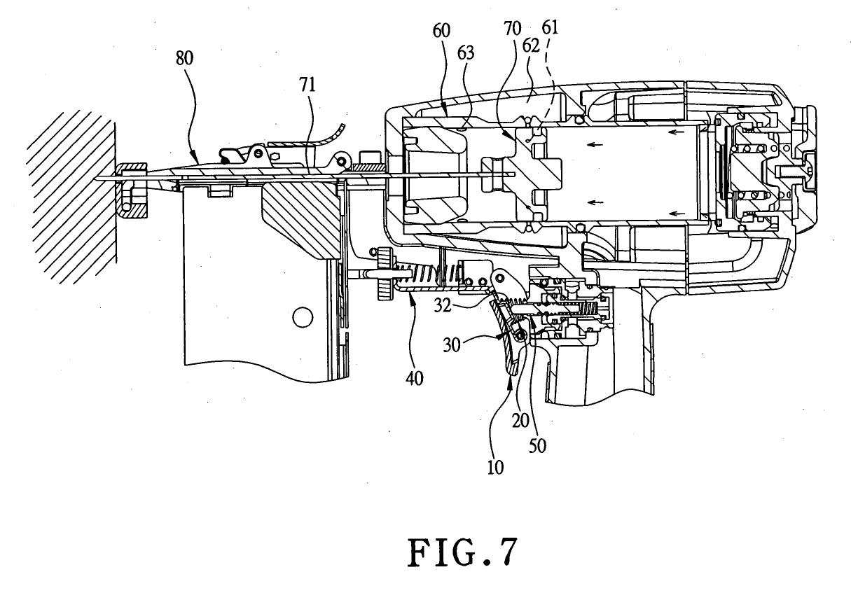

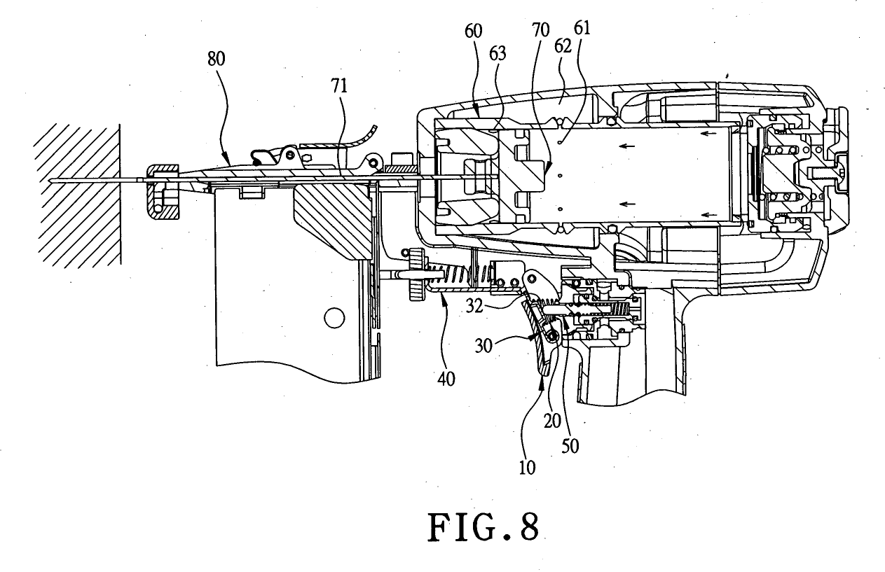

(2) The special condition: Should a nail not be smoothly stricken into a work after triggering of the nail gun and should the piston 70 stop at the middle of its stroke blocking the wind holes 61 of the cylinder 60, the projection 32 of the press plate could overcome this condition. In detail, a user pushes the safety arm 40 according to the processes shown in FIGS. 3 and 4, and a nail is not completely stricken out as shown in FIG. 7, with the piston 70 stopping at a middle section in the cylinder 60 blocking the wind holes 61, with the inner end of the safety arm 40 separated from the press plate 30 to let the press plate 30 return to its original position. But, as shown in FIG. 8, the trigger 10 is still in the pressed condition, and the projection 32 can keep on pushing the valve switch 50 so that pressured air can continue to flow into the cylinder 60 and push forward further the piston 70 stopped at the middle section of the cylinder 60, overcoming the stopped condition of the piston 70 and enabling the piston 70 to move further forward in a very short time. At the same time the blocked wind holes 61 are also cleared open. Then the user can release the trigger 10 to permit the piston 70 automatically return to its normal position. Thus, the simple provision of the projection 32 of the press plate 30 can effectively prevent the nail from stricken intermittently or from stricken in vain.

While the preferred embodiment of the invention has been described above, it will be recognized and understood that various modifications may be made therein and the appended claims are intended to cover all such modifications that may fall within the spirit and scope of the invention.

1. An orderly single striking device for a nail gun, said device comprising a press plate positioned behind a trigger of a nail gun and elastically and pivotally secured, said press plate moved together with said trigger and pivotally rotated by an inner end of a safety arm in due time to push a valve switch to actuate triggering; and,
Characterized by a projection formed integral and recessed inward by pressing process in an upper section of said press plate to contact and push always said valve switch; plural wind holes formed in an annular wall of a cylinder, said projection of said press plate possible to keep on pushing said valve switch even if said press plate returned to its original position in case that said wind holes are blocked by said piston being moved forward in said cylinder after said trigger is pulled and said inner end of said safety arm is separated from said press plate at the same time, then pressured air possible to continue flowing in said cylinder to push forward further said piston so as to get rid of the blocked condition of said wind holes, thus nail striking action possible to be finished smoothly and preventing a nail from stricken intermittently or in vain, and operational efficiency of said nail gun possible to be upgraded.

2. The orderly single striking device for a nail gun as claimed in claim 1, wherein said projection is formed integral with said press plate.
